(19) United States
(12) Patent Application Publication
(10) Pub. No.: US 2025/0185664 A1
(43) Pub. Date: Jun. 12, 2025

(54) ANTIBACTERIAL COMPOSITION FOR GLASS COATING AND ANTIBACTERIAL GLASS

(71) Applicant: RIGMAH GLASS Co., Ltd., Cheongju-si (KR)

(72) Inventor: Changhwan SUNG, Sejong-si (KR)

(21) Appl. No.: 18/532,571

(22) Filed: Dec. 7, 2023

(30) Foreign Application Priority Data
Dec. 6, 2023 (KR) 10-2023-0175661

(51) Int. Cl. A01N 59/20; A01P 1/00; C03C 17/00; C09D 5/14; C09D 183/00

(52) U.S. Cl. CPC A01N 59/20; A01P 1/00; C09D 5/14; C09D 183/00; C03C 17/001; C03C 2218/118

(57) ABSTRACT

The antibacterial composition for glass coating of the present invention includes about 0.3 wt % to 15 wt % of copper nitrate; about 70 wt % to 95 wt % of a solvent; and about 0.1 wt % to 15 wt % of a structure former. The antibacterial composition for glass coating and antibacterial glass can increase the distribution of antibacterial particles on the surface of the coating layer, and have excellent hardness, weather resistance, and antifouling properties.

### CROSS-REFERENCE TO RELATED APPLICATION

This application claims priority to Korea Patent Application No. 10-2023-0175661, filed Dec. 6, 2023, the contents of which are incorporated herein by reference in their entirety.

### FIELD OF THE INVENTION

The present invention relates to an antibacterial composition for glass coating and antibacterial glass.

### DESCRIPTION OF THE RELATED ART

Currently, there is a high interest in the field of enhancing business feasibility using various types of contents. For example, beyond simply providing videos or holding performances with respect to movies, animations, performances, concerts, and characters, there are many cases for selling goods using a character that appears in a corresponding movie, animation, or performance or an artist of a concert, or making continuous revenues through a social network service (SN) or a video channel.

As such, although techniques using movies, animations, performances, concerts, and characters are increasing, the techniques are still being used in limited technical fields.

Also, if corresponding viewing is satisfactory even after actual viewing, there may be a high desire to remember or feel an emotion again. However, it is a situation that cannot but be satisfied with an evidence shot taken at a corresponding location.

Therefore, there is a need for an augmented reality/virtual reality (AR/VR)-based content production and utilization platform that allows users to experience a variety of pleasures while viewing movies, performances, concerts, sports, etc., and to experience impressive viewing again.

### SUMMARY OF THE INVENTION

One aspect of the present invention relates to an antibacterial composition for glass coating.

According to one specific embodiment, the antibacterial composition for glass coating comprises about 0.3 wt % to 15 wt % of copper nitrate; about 70 wt % to 95 wt % of a solvent; and about 0.1 wt % to 15 wt % of a structure former.

The copper nitrate may have an average particle diameter (D50) ranging from 8 nm to 25 nm.

The solvent may include one or more of alcohol-based solvents, silanol-based solvents, and alkoxy-silane-based solvents.

The alcohol-based solvent can be an alcohol of C1 to C10.

The silanol-based solvent may include trialkylsilanols.

The alkoxy-silane-based solvent can be represented by the chemical formula 1:

R⁴ₓSi(OR⁵)₄₋ₓ [Chemical formula 1]
where R4 is a C1 to C10 alkyl group, a C6 to C10 aryl group, or a C3 to C10 alkenyl group; R5 is a C1 to C6 alkyl group; and x is an integer satisfying 0≤x<4.

The copper nitrate and the structure former may have a density difference of 1.0 or less.

The structure former may include one or more of polysilazane and dimethyldiphenyl polysiloxane.

The polysilazane may be a compound represented by the chemical formula 2:

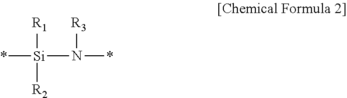

Another aspect of the present invention relates to antibacterial glass.

The antibacterial glass comprises a glass substrate; and an antibacterial coating layer formed on the glass substrate. The antibacterial coating layer may be formed of the antibacterial composition for glass coating.

The antibacterial coating layer may have a thickness ranging from 300 nm to 800 nm.

### BRIEF DESCRIPTION OF DRAWINGS

FIG. 1 provides a concise representation of a cross-section of antibacterial glass according to an example embodiment;

### DETAILED DESCRIPTION OF THE INVENTION

Example embodiments of the present disclosure will hereinafter be described in more detail, and may be easily performed by those who have knowledge in the related art. However, this disclosure may be embodied in many different forms, and should not be construed as being limited to the Example embodiments set forth herein.

### Antibacterial Coating Composition for Glass

The antibacterial composition for glass coating according to a specific embodiment of the present invention comprises about 0.3 wt % to 15 wt % of copper nitrate; about 70 wt % to 95 wt % of a solvent; and about 0.1 wt % to 15 wt % of a structure former.

The copper nitrate, represented by the chemical formula Cu(NO₃)₂, is a substance with antibacterial and biopurifying resistance. It has a density of 2.0 to 2.1, specifically 2.047, and a boiling point of 170° C.

The copper nitrate may have an average particle diameter (D50) ranging from 8 nm to 25 nm. Within this particle size range, not only can sufficient antibacterial properties be achieved, but there is also an effect of densely adhering to the surface due to the influence of density and surface tension within the structure former and solvent.

The copper nitrate can be included in the antibacterial composition for glass coating in the range of 0.3 to 15% by weight, specifically 5 to 14% by weight, more specifically 8 to 12% by weight. In this range, it can prevent deterioration of light transmittance and weather resistance while achieving excellent self-cleaning, antibacterial, and superhydrophilic effects.

The solvent may include one or more of alcohol-based solvents, silanol-based solvents, and alkoxy-silane-based solvents.

The alcohol-based solvent can be an alcohol of C1 to C10, such as methanol, ethanol, n-butanol, octanol, and the like. When applying the alcohol-based solvent, it ensures the solubility of the structure former and simultaneously secures the dispersibility of copper nitrate.

Specific examples of the silanol-based solvent include trialkylsilanols such as trimethylsilanol and triethylsilanol. Here, alkyl may be a substituted or unsubstituted alkyl of C1 to C10.

In particular, when using the antibacterial composition for glass coating of the present invention, the above-mentioned copper nitrate, solvent, and structure former are effectively combined to provide enhanced antibacterial, self-cleaning, and weather-resistant properties.

The alkoxysilane-based solvent is represented by Chemical Formula 1.

R⁴ₓSi(OR⁵)₄₋ₓ [Chemical Formula 1]
where R4 is a C1 to C10 alkyl group, a C6 to C10 aryl group, or a C3 to C10 alkenyl group; R5 is a C1 to C6 alkyl group; and x is an integer satisfying 0≤x<4.

The alkoxysilane solvent represented by Chemical Formula 1 may include at least one compound selected from the group consisting of tetramethoxysilane, tetraethoxysilane, tetrapropoxysilane, tetraisopropoxysilane, tetra-n-butoxysilane, tetra-sec-butoxysilane, tetra-tert-butoxysilane, trimethoxysilane, triethoxysilane, methyltrimethoxysilane, methyltriethoxysilane, ethyltrimethoxysilane, ethyltriethoxysilane, propyltrimethoxysilane, prop yltriethoxysilane, isobutyltriethoxysilane, cyclohexyltrimethoxysilane, phenyltrimethoxysilane, phenyltriethoxysilane, vinyltrimethoxysilane, vinyltriethoxysilane, allyltrimethoxysilane allyltriethoxysilane, dimethyldimethoxysilane, dimethyldiethoxysilane, diphenyldimethoxysilane, diphenyldiethoxysilane, and combinations thereof, without being limited thereto.

The antibacterial particles employed possess a notable specific gravity, causing them to settle at the composition's bottom due to gravity. When the antibacterial composition undergoes drying/curing in a precipitated state, a challenge arises in that the specific antibacterial particles on the surface are minimized, hindering the full manifestation of antibacterial properties.

The antibacterial composition for glass coating in this invention addresses this issue by incorporating low-specific-gravity copper nitrate as antibacterial particles. This approach minimizes the specific gravity difference between the structure former and the solvent. Consequently, not only does it enhance the dispersibility of antibacterial particles within the composition, but it also maximizes the distribution of antibacterial particles on the coating layer surface.

In a specific scenario, the specific gravity difference between copper nitrate and the structure-forming agent may be 1.0 or less, with the specific gravity of copper being, for instance, 2.047.

To manage the specific gravity difference, the antibacterial composition for glass coating in this invention identifies and incorporates a component with high specific gravity as a structure-forming agent. Specifically, the structure-forming agent may encompass at least one of polysilazane and dimethyldiphenyl polysiloxane.

In one embodiment, the polysilazane includes a silicon-nitrogen (Si—N) bond unit represented by Chemical Formula 2.

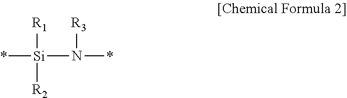

In Chemical Formula 2, R1 to R3 may each independently be hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a carboxyl group, an aldehyde group, a hydroxy group, or a combination thereof, and “*” may indicate a linking point (e.g., coupling position).

As used herein, the term “substituted” means that at least one hydrogen atom is substituted with a halogen atom, a hydroxyl group, a nitro group, a cyano group, an amino group, an azido group, an amidino group, a hydrazino group, a carbonyl group, a carbamyl group, a thiol group, an ester group, a carboxyl group or a salt thereof, a sulfonic acid group or a salt thereof, a phosphate group or a salt thereof, a C1 to C20 alkyl group, a C2 to C20 alkenyl group, a C2 to C20 alkynyl group, a C1 to C20 alkoxy group, a C6 to C30 aryl group, a C6 to C30 aryloxy group, a C3 to C30 cycloalkyl group, a C3 to C30 cycloalkenyl group, a C3 to C30 cycloalkynyl group, or combinations thereof.

The polysilazane is transformed into dense silica glass by heating and oxidation. The polysilazane includes a silicon-nitrogen (Si—N) bond unit, a silicon-hydrogen (Si—H) bond unit, and a nitrogen-hydrogen (N—H) bond unit as a backbone. In the polysiloxazane, the (Si—N) bond can be substituted with a (Si—O) bond through baking or curing.

In one embodiment, the polysilazane has a terminal group represented by Chemical Formula 3.

*—SiH₃ [Chemical Formula 3]

The terminal group represented by Chemical Formula 3 may be included in an amount of about 15 wt % to about 35 wt % based on the total weight of Si—H bonds in the polysilazane. When the terminal group represented by Chemical Formula 3 is included in the polysilazane structure within this amount range, loss of the SiH3 moiety via conversion into SiH4 when an oxidation reaction occurs during heat treatment may be prevented or reduced, and cracks in a hard coating layer may be prevented.

For example, the terminal group represented by Chemical Formula 3 may be included in an amount of about 20 wt % to about 30 wt % based on the total weight of Si—H bonds in the polysilazane.

The polysilazane may have a weight average molecular weight (Mw) of about 1,000 g/mol to about 5,000 g/mol. Within this range, it is possible to reduce evaporation loss during heat treatment and to form a dense organic-inorganic hybrid layer by thin film coating. Preferably, the polysiloxazane has a weight average molecular weight (Mw) of about 1,500 g/mol to about 3,500 g/mol.

The polysilazane can be incorporated in quantities ranging from 0.1 to 15 wt %, more specifically, from 0.5 to 7 wt %, and particularly, from 1 to 4 wt % by weight, calculated based on the overall content of the antibacterial composition for glass coating. Within this specified range, maintaining an optimal viscosity is achievable, leading to the manifestation of superb weather resistance and antifouling effects, while concurrently augmenting the surface distribution of the antibacterial particles.

### Antibacterial Glass

Another aspect of the present invention relate to antibacterial glass.

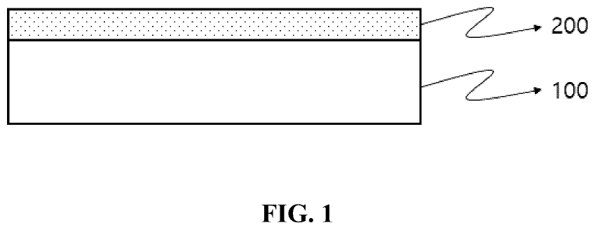

Referring to FIG. 1, the antibacterial glass comprises a glass substrate 100 and an antibacterial coating layer 200 formed on the glass substrate 100. The antibacterial coating layer 200 is constructed using the antibacterial composition for glass coating.

Specifically, the manufacturing process for the antibacterial coating layer 200 may include the antibacterial composition for glass coating onto one surface of a substrate, and performing curing process of the coating layer.

the antibacterial composition for glass coating may be coated by roll coating, spin coating, bar coating, dip coating, flow coating, and/or spray coating, without being limited thereto.

The coating thickness may range from 300 to 800 nm. Within this specified coating thickness range, the antibacterial glass exhibits outstanding antibacterial, antifouling, scratch resistance, and wear resistance properties.

The curing process may involve room temperature curing or ultraviolet curing.

Room temperature curing, accomplished through natural drying at room temperature for 1 to 5 minutes post-application, facilitates non-vacuum wet coating, resulting in a brief manufacturing time and excellent processability.

Ultraviolet curing serves to reduce the bonding energy within the silicon-nitrogen (Si—N), silicon-hydrogen (Si—H), or nitrogen-hydrogen (N—H) bonds of polysilazane in the glass-coated antibacterial composition, essentially breaking them. This process, which may include vacuum ultraviolet treatment, enhances the conversion rate to silica. Specifically, the vacuum ultraviolet rays employed range from 100 to 200 nm, with the irradiation intensity set at 10 to 200 mW/cm², irradiation amount at 100 to 6,000 mJ/cm², and, more precisely, 1,000 to 5,000 mJ/cm², during a 0.1 to 5-minute duration.

The antibacterial glass of the current invention demonstrates exceptional antifouling capabilities, as the titanium dioxide within the antibacterial coating layer 200 enables self-cleaning through photocatalytic decomposition, effectively eliminating bacteria.

The antibacterial coating layer 200, acting as a silica carrier supporting moisture from polysilazane, maintains super hydrophilicity. Consequently, it exhibits outstanding superhydrophilicity when applied to glass substrates like smartphone glass, automobile windshields, side mirrors, and bathroom surfaces.

Notably, the antibacterial coating layer 200 demonstrates robust adhesion between the glass substrate 100 and itself, boasting superior wear resistance, scratch resistance, weather resistance, and more, making it suitable for applications such as vehicle or architectural windows.

The antibacterial coating layer 200, derived from the antibacterial composition for glass coating of this invention, may achieve a pencil hardness of 7H or greater, specifically ranging from 7H to 9H, ensuring outstanding scratch and wear resistance.

Furthermore, the antibacterial coating layer 200 from the antibacterial composition for glass coating may exhibit a water droplet contact angle of 5° or less, particularly 3° or less, showcasing superhydrophilicity within this specified range.

Lastly, the antibacterial coating layer 200, when subjected to testing per ASTM D-4587 regulations, exhibits exceptional weather resistance with a color difference value (ΔE) of 0.3 or less.

### MODE FOR INVENTION

Hereinafter, the present invention will be described in more detail with reference to some examples. However, it should be understood that these examples are provided for illustration only and are not to be construed in any way as limiting the present invention. A description of details apparent to those skilled in the art will be omitted for clarity.

### Example 1

Into a 2 L reactor provided with an agitator and a temperature controller, the inner atmosphere of which was previously replaced with dried nitrogen, a mixture obtained by sufficiently mixing 1,500 g of dried pyridine and 2.0 g of pure water was placed and maintained at 5° C. Then, 100 g of dichlorosilane was slowly introduced into the reactor for 1 hour, followed by stirring while slowly introducing 70 g of ammonia into the reactor over the course of 3 hours. Thereafter, the reactor was purged with dried nitrogen for 30 minutes to remove residual ammonia from the reactor. The obtained product had a white slurry phase and was filtered under a dried nitrogen atmosphere using a Teflon membrane filter having a pore size of 1 m, thereby obtaining 1,000 g of filtrate. After 1,000 g of dried xylene was added to the filtrate, an operation of substituting xylene for pyridine, as a solvent, was performed three times using a rotary evaporator to adjust a solid content to 20%, followed by filtration through a Teflon membrane filter having a pore size of 0.03 m, thereby preparing a polysilazane. The obtained polysilazane contained 0.5% of oxygen and had a SiH3/SiH (total) value of 0.20 and a weight average molecular weight of 2,000 g/mol.

A solvent comprising 87% by weight of ethanol was added to 2% by weight of the previously prepared polysilazane. The mixture was stirred for 16 hours, with an initial stirring speed of 180 rpm for the first 6 hours and subsequently reduced to 90 rpm. Following the completion of the stirring process for the polysilazane and the solvent, 10% by weight of copper nitrate with an average particle diameter (D50) of 15 nm was added and stirred for an additional 2 hours, resulting in the formulation of an antibacterial composition for glass coating.

To create antibacterial glass, the prepared antibacterial composition for glass coating was roll-coated onto a 3 mm thick glass substrate, achieving a coating thickness of 300 nm. Subsequently, the coated glass was cured at room temperature for 5 minutes.

The physical properties of the antibacterial glass were evaluated using the specified physical property evaluation method, and the obtained results are detailed in Table 1 below.

TABLE 1

| Item | | Example 1 |
|---|---|---|
| composition | (A) Polysilazane | 2 |
| (wt %) | (B) Ethanol | 87.5 |
| | (C) copper nitrate | 10.5 |
| Properties | Pencil hardness | 8 H |
| | Water contact angle | 4° |
| | ΔE | 0.3 |
| | Antibacterial test | ND |

### Evaluation of Properties

Pencil hardness: Pencil hardness is measured using a HEIDON-14EW instrument from SHINTO Scientific. (pencil: MITSUBISHI Co., speed: 60 mm/min, scale: 10.0 mm, force: 19.6 N, the load: 1 kg, angle: 45°)

Water drop test: Using an automatic contact angle meter DM700 (manufactured by Kyowa Interface Science Co., Ltd.), 2 of pure water is dropped on the hard coating layer to measure the water contact angle.

Accelerated weatherability test: The color difference value (ΔE) of the hard coating film prepared in accordance with ASTM D-4587 is measured. AE is measured by quantifying the degree of discoloration of the hard coating film before and after exposure to ultraviolet light after exposing the hard coating film to ultraviolet light (UV) for 2,000 hours.

Antibacterial test: The hard coating film prepared according to the examples is put into 1 L of a solution containing 4,000 CFU/ml of Escherichia coli, and the number of E. coli cells after 24 hours is measured. Escherichia coli was measured 24 hours after the solution containing only Escherichia coli as a control group, and the number of Escherichia coli in the control group after 24 hours was 8,000 CFU/ml.

As shown in the results in Table 1, the antibacterial coating layer prepared using the antibacterial composition for glass coating in Example 1 of the present invention exhibits superior hardness, along with a water droplet contact angle of 5° or less, indicating superhydrophilicity. Additionally, it demonstrates excellent weather resistance and antibacterial properties.

While this present disclosure has been described in connection with what is presently considered to be practical Example embodiments, it is to be understood that the present disclosure is not limited to the disclosed embodiments, but, on the contrary, is intended to cover various modifications and equivalent arrangements included within the spirit and scope of the appended claims and equivalents thereof.

What is claimed is:

1. An antibacterial composition for glass coating comprising:
about 0.3 wt % to 15 wt % of copper nitrate;
about 70 wt % to 95 wt % of a solvent; and
about 0.1 wt % to 15 wt % of a structure former.

2. The antibacterial composition for glass coating coating according to claim 1, wherein the copper nitrate is an antibacterial composition for glass coating with an average particle diameter (D50) ranging from 8 nm to 25 nm.

3. The antibacterial composition for glass coating coating according to claim 1, wherein the solvent comprises one or more of alcohol-based solvents, silanol-based solvents, and alkoxy-silane-based solvents in the antibacterial composition for glass coating.

4. The antibacterial composition for glass coating coating according to claim 3, wherein the alcohol-based solvent is an antibacterial composition for glass coating containing alcohols of C1 to C10.

5. The antibacterial composition for glass coating coating according to claim 3, wherein the silanol-based solvent is an antibacterial composition for glass coating containing trialkylsilanol.

6. The antibacterial composition for glass coating coating according to claim 3, wherein the alkoxy-silane-based solvent is a compound represented by the chemical formula 1 in the antibacterial composition for glass coating:
R⁴ₓSi(OR⁵)₄₋ₓ [Chemical Formula 1]
wherein R4 is a C1 to C10 alkyl group, a C6 to C10 aryl group, or a C3 to C10 alkenyl group; R5 is a C1 to C6 alkyl group; and x is an integer satisfying 0≤x<4.

7. The antibacterial composition for glass coating coating according to claim 1, wherein the copper nitrate and the structure former in the antibacterial composition for glass coating have a specific gravity difference of 1.0 or less.

8. The antibacterial composition for glass coating coating according to claim 1, wherein the structure former is an antibacterial composition for glass coating containing at least one of polysilazane and dimethyldiphenyl polysiloxane.

9. The antibacterial composition for glass coating coating according to claim 8, wherein the polysilazane is an antibacterial composition for glass coating characterized by having a basic skeleton structure containing silicon-nitrogen (Si—N) bonds, represented by the chemical formula 2:
▮ [Chemical Formula 2]
In Chemical Formula 2, R1 to R3 may each independently be hydrogen, a substituted or unsubstituted C1 to C30 alkyl group, a substituted or unsubstituted C3 to C30 cycloalkyl group, a substituted or unsubstituted C6 to C30 aryl group, a substituted or unsubstituted C7 to C30 arylalkyl group, a substituted or unsubstituted C1 to C30 heteroalkyl group, a substituted or unsubstituted C2 to C30 heterocycloalkyl group, a substituted or unsubstituted C2 to C30 alkenyl group, a substituted or unsubstituted alkoxy group, a carboxyl group, an aldehyde group, a hydroxy group, or a combination thereof, and “*” may indicate a linking point.

10. Antibacterial glass comprising:
a glass substrate; and
an antibacterial coating layer formed on the glass substrate,
wherein the antibacterial coating layer is an antibacterial glass formed with the antibacterial composition for glass coating of claim 1.

11. The antibacterial glass according to claim 10, wherein the antibacterial coating layer is an antibacterial glass formed with a thickness of 300 nm to 800 nm.
